(19) United States
(12) Patent Application Publication
(10) Pub. No.: US 2025/0000248 A1
(43) Pub. Date: Jan. 2, 2025

(54) Barbecue Grill Brush

(71) Applicant: Scrub Daddy, Inc., Pennsauken, NJ (US)

(72) Inventors: Aaron C. Krause, Pennsauken, NJ (US); John O'Brien, Pennsauken, NJ (US); Aleksandrs Titovs, Pennsauken, NJ (US)

(21) Appl. No.: 18/709,147

(22) PCT Filed: Feb. 9, 2023
(86) PCT No.: PCT/US2023/012662

§ 371 Date: May 10, 2024

Related U.S. Application Data
(60) Provisional application No. 63/310,220, filed on Feb. 15, 2022.

(51) Int. Cl. A46B 15/00; A46B 5/00; A46B 5/02; A46B 9/00; A47J 37/07

(52) U.S. Cl. CPC A46B 15/0081; A46B 5/0095; A46B 5/021; A46B 9/005; A46B 15/0063; A47J 37/0786; A46B 2200/3073

(57) ABSTRACT

A barbeque grill brush (10) includes an elongated brush handle (12) with a handle grip (14) extending perpendicularly from one end thereof. The other end of the brush handle (12) includes a brush holder (16) that carries two rigid metal scrapers (30) and (32) and a brush head (34). The brush head (34) is carried by a brush attachment (36) that is adapted to be secured to or removed from the brush holder (36). The brush head (34) is comprised of a stainless steel mesh (46) covered foam (48). The foam (48) has the characteristics of being firm when cold but soft when heated.

### FIELD OF THE INVENTION

The invention relates to a brush and scraper of the kind used to clean barbecue grills and similar cooking surfaces.

### BACKGROUND OF THE INVENTION

Barbecuing food, particularly in the summer, is a very popular activity for many people, especially in the suburbs. As is well known in the art, barbecue grills come in many shapes and sizes and the heat source may come from propane or natural gas, charcoal, or wood or the like. All barbecue grills, however, include a cooking surface comprised of a grate made of a series of parallel metal bars.

When cooking on the grate, juices from the food and from sauces and the like spread on the food accumulates on the grate and must, from time to time, be removed. This is normally done with a grill brush and/or scraper. Over the years, numerous different brushes have been proposed. While they all have some cleaning effect, the majority do not effectively remove the accumulated deposits and many are difficult to use.

One brush that has met with some success is shown and described in U.S. Pat. No. 8,202,016, the entire contents of which are incorporated herein by reference. This prior brush, however, continues to suffer from various drawbacks which the present invention is designed to overcome.

### BRIEF DESCRIPTION OF THE DRAWINGS

For the purpose of illustrating the invention, there is shown in the accompanying drawings one form which is presently preferred; it being understood that the invention is not intended to be limited to the precise arrangements and instrumentalities shown.

FIG. 1 is a front and top perspective view of a barbecue grill brush of the invention;

FIG. 2 is a view similar to FIG. 1 but partially in cross-section and with the brush head removed;

FIG. 3 is a perspective view of the brush head of the invention;

FIG. 4 is a perspective view similar to FIG. 1 illustrating the manner in which the brush of the invention may be held during use;

FIG. 5 is a perspective view of the barbecue grill brush of the invention inverted for use in a slightly different manner and having the knob rotated;

FIG. 6 is a perspective view similar to FIG. 5 showing the bottle opening feature of the invention;

FIG. 7 is a partial cross-sectional view of the brush head of the invention;

FIG. 8 illustrates the manner in which a portion of the grill brush can be used to lift a grate from a barbecue grill, and

FIG. 9 is a view illustrating how the brush of the present invention is used for scraping a grate of a barbecue grill.

### DETAILED DESCRIPTION OF THE PREFERRED EMBODIMENT

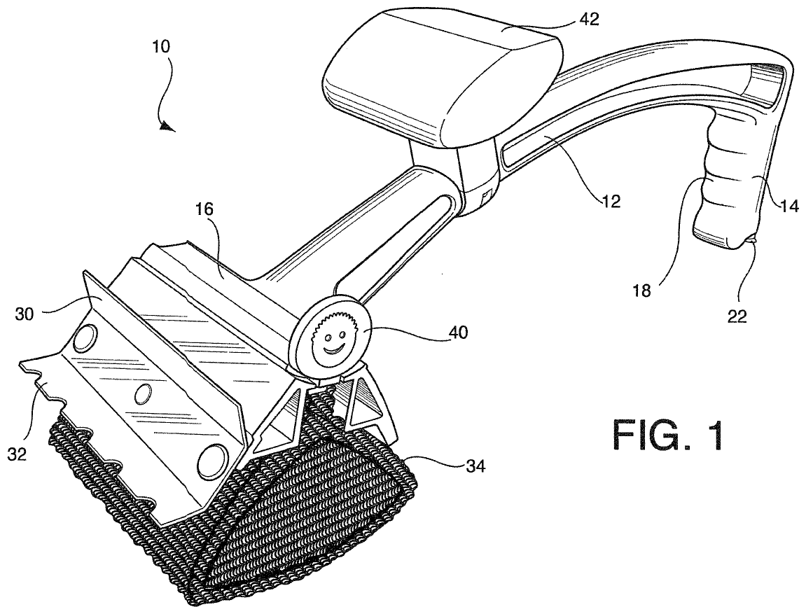

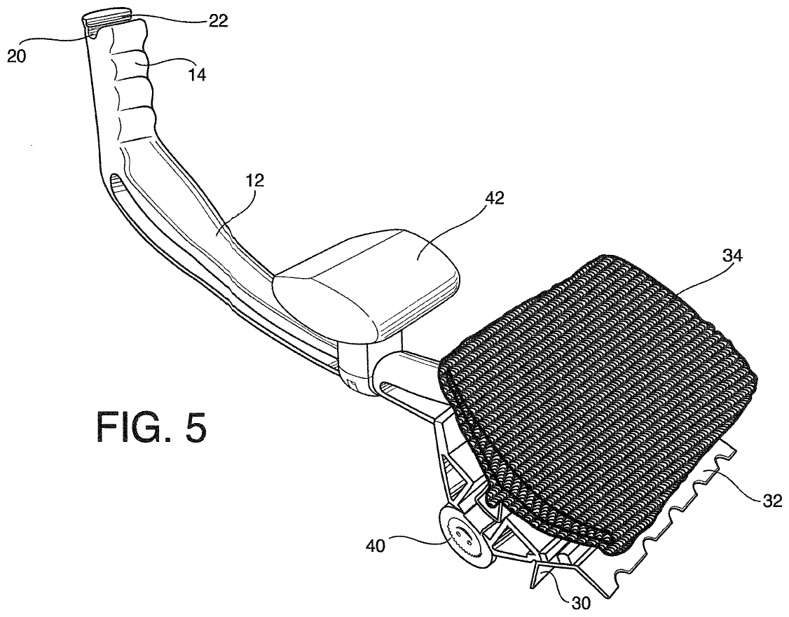

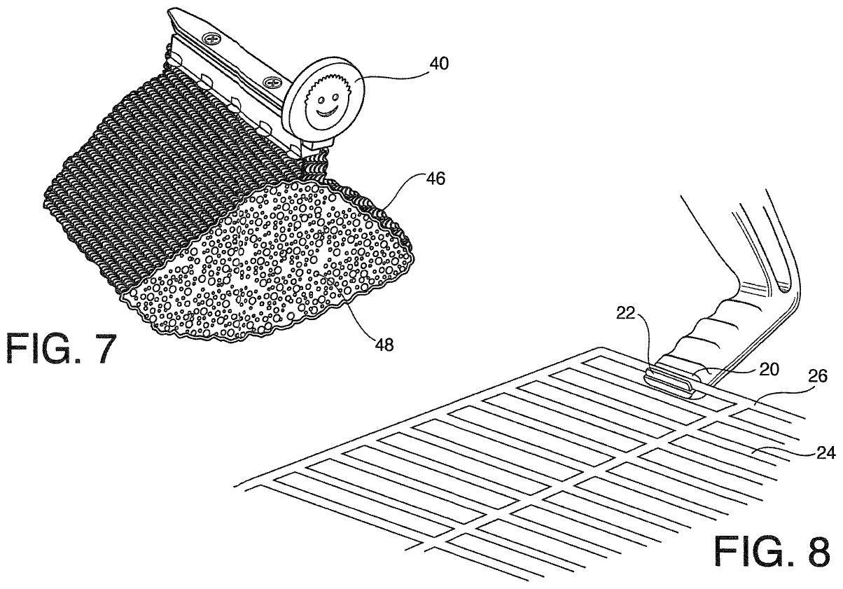

Referring now to the drawings in detail wherein like reference numerals have been used throughout the various figures to designate like elements, there is shown in FIGS. 1-9 a barbecue grill brush constructed in accordance with the principles of the present invention and designated generally as 10.

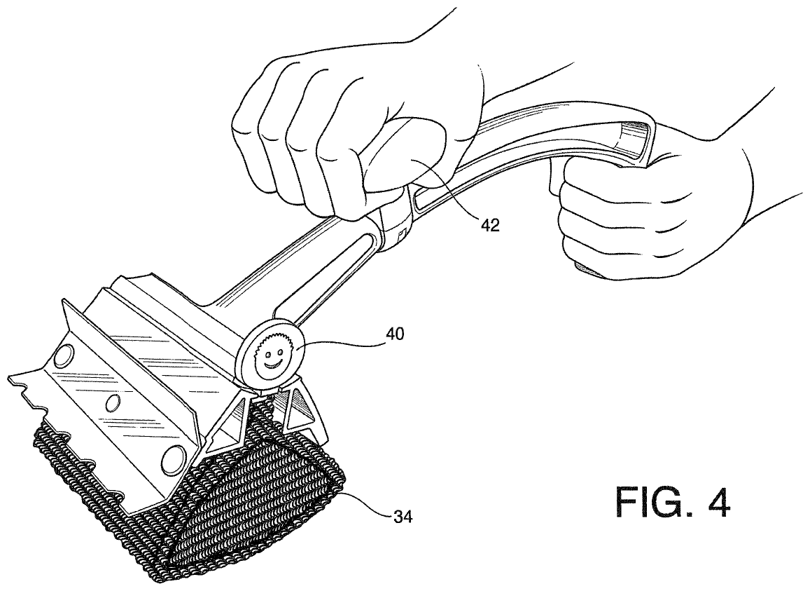

The brush 10 is comprised of an elongated brush handle 12 having a hand grip 14 at one end thereof and a brush holder 16 at the other end. As viewed in FIG. 1, the hand grip 14 extends downwardly at approximately 90′ to the curved axis of the main handle 12. The hand grip 14 also includes a plurality of finger indentations 18 which makes it easier for a person to grasp the same as seen in FIG. 4.

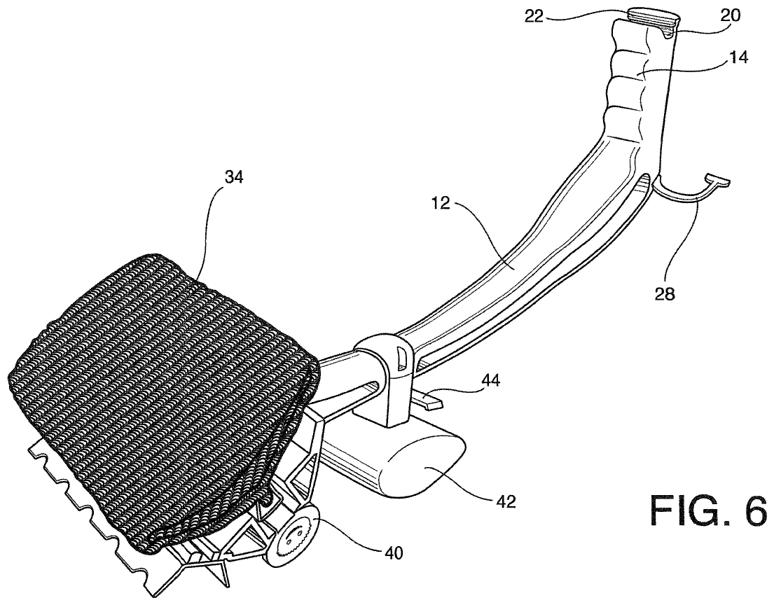

The very bottom rear end of the handle grip 14 also includes a transverse recess 20 bordered adjacent the top of the recess by a metal extension 22. As best seen in FIG. 8, the combination of the recess or slot 20 and the metal extension 22 can be used to lift a barbecue grate 24 by engaging one of the bars 26 thereof. The upper end of the handle grip also includes a bottle opener 28 that is pivotally connected thereto so that it can either be exposed for use as shown in FIG. 6 or rotated into a slot in the rear of the handle grip so as to be out of the way.

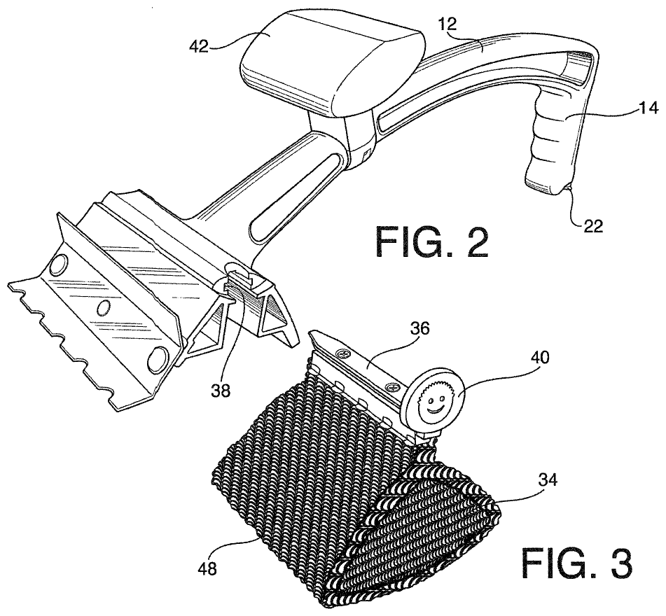

The brush holder 16, at the other end of the handle 14, includes a transverse straight metal scraper 30 and a transverse grooved metal scraper 32 at the top of the grill brush 10 as viewed from FIG. 1. Extending downwardly from the brush holder 16 (as viewed in FIG. 1) is the brush head 34. As shown most clearly in FIGS. 2 and 3, the brush head 34 can be removed from the brush holder 16 and reinserted therein through the use of the brush attachment 36 that can slide into and out of the slotted groove 38. This allows the brush head 34 to be removed for cleaning or replacement. The thumb handle 40 on the end of the brush attachment 36 makes it easier to remove or insert the same into the groove 38.

As shown in FIG. 4, when it is desired to clean a grate 24 with the brush head 34, a person holds the handle grip 14 with one hand and the knob 42 (located intermediate the two ends of the brush handle) with the other hand. Putting downward pressure on the knob 42 makes it easier to clean the grate and it is also easier on the hands and arms of the person cleaning the grate 24.

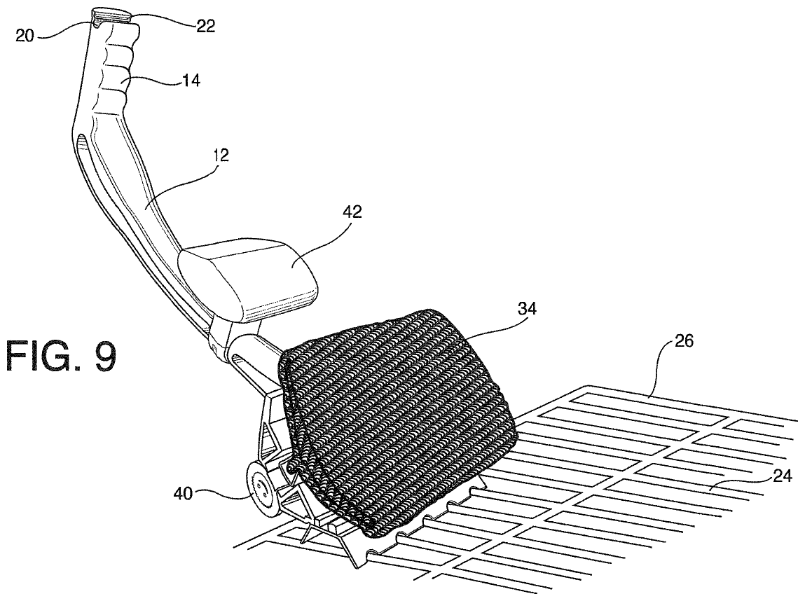

Sometimes, however, it is desired to use the straight metal scraper 30 or the grooved metal scraper 32 to clean the grate 24. To accomplish this, the barbecue brush 10 is inverted so as to be in the position shown in FIGS. 6 and 9. In order that the knob 42 can also be used in this position, it is mounted on the brush handle 12 so as to be rotatable relative thereto. This allows the knob to be moved between the position shown in FIG. 1 and the position shown in FIG. 9. Means are also provided to ensure that the knob 42 locks into one of the two desired positions. A lever 44 is used to release the lock to allow for rotation.

The brush head 34 is comprised essentially of two parts: an outer stainless steel mesh cover 46 and inner foam 48. The foam 48 is preferably made from a specific foam material such as that described in our prior U.S. Published Application No. 2016/0213221, published on Jul. 28, 2016, the entire contents of which are incorporated herein by reference. As explained therein and in Applicant's prior application Ser. No. 13/617,762 (the entire contents of which are also incorporated herein by reference) the foam 48 has the characteristics of being relatively rigid at cold temperatures, such as 50-60° F., for example, but becomes softened at elevated temperatures above 100° F., for example. This is accomplished by utilizing base thermoplastic materials such as polyurethanes, polyesters and related compositions and mixing them with thermoplastic materials that may have soft or putty-like characteristics at different temperatures. Examples are capero-lactones and related thermoplastics such as sold under the names Protoplast or Draco. As is also well known in the art, polymer compositions can be further cross-linked for increased temperature settings, durability, structural strength and the like. In addition, various other additives can be employed.

The foam 48 in the brush head 34 made from the materials described above will have the characteristics of being relatively firm or rigid at cold temperatures but relatively soft at elevated temperatures. In use, the brush head 34 is first dipped into cold water to make it hard, initially, therefore, the brush head is hard and can effectively scrape the grate to clean it As the brush head 34 continues to clean the hot grate 24, the foam softens, This allows the brush head to mold itself around the grate bars to clean the sides thereof. After use, the brush head can then again be immersed in cold water and regain its hardness

Although the invention has been described in accordance with the preferred embodiment, it will be appreciated by those skilled in the art that the application of the present invention is useful in a variety of configurations and designs not specifically described above. All such designs and applications are considered to be within the scope of the present disclosure, and the invention is applicable across a wide variety of applications. Such applications are considered within the scope and spirit of the present invention.

In as far as a description above and the accompanying drawings disclose any additional subject matter that is not within the scope of the claims below, the inventions are not dedicated to the public and the right to file other applications to claim any additional inventions is reserved.

1. A barbecue grill brush comprised of:
an elongated brush handle having a first end, a second end, a top and a bottom;
a hand grip attached to one end of said brush handle and extending substantially perpendicularly thereto;
a brush holder attached to the other end of said brush handle;
a metal mesh-covered foam brush head carried by and extending from said brush holder;
said foam of said brush head comprised of a material that is rigid when cold but soft when heated, and
a metal scraper also extending from said other end of said brush handle.

2. The barbecue grill brush as claimed in claim 1 wherein said mesh-covered foam is carried by a brush attachment that is adapted to be attached to or removed from said brush holder for cleaning or replacement.

3. The barbecue grill brush as claimed in claim 1 wherein said mesh is comprised of stainless steel.

4. The barbecue grill brush as claimed in claim 3 wherein said mesh-covered foam is carried by a brush attachment that is adapted to be attached to or removed from said brush holder for cleaning or replacement.

5. The barbecue grill brush as claimed in claim 4 wherein said brush head includes an elongated brush attachment and said brush holder includes an elongated slot into which said brush attachment is adapted to slide into or out of.

6. The barbecue grill brush as claimed in claim 5 wherein said brush attachment includes a thumb handle for assisting a user in inserting the brush head into the brush holder.

7. The barbecue grill brush as claimed in claim 1 including a rigid metal scraper carried by said brush holder.

8. The barbecue grill brush as claimed in claim 7 including a second rigid metal scraper carried by said brush holder.

9. The barbecue grill brush as claimed in claim 1 including a knob extending from said brush handle between said ends thereof.

10. The barbecue grill brush as claimed in claim 9 wherein said knob is mounted for rotation about said brush handle.

11. The barbecue grill brush as claimed in claim 1 including a bottle opener carried by said handle grip.
